(19) United States
(12) Patent Application Publication
(10) Pub. No.: US 2004/0139881 A1
(43) Pub. Date: Jul. 22, 2004

(54) Technology for printing luminescent pictorial images

(75) Inventors: Douglas Kaz, Huntington Beach, CA (US); Komei Shibata, Huntington Beach, CA (US)

Correspondence Address: Koda & Androlia, Suite 3850, 2029 Century Park East, Los Angeles, CA, 90067, US

(73) Assignee: Hirotec, Inc.

(21) Appl. No.: 10/338,583

(22) Filed: Jan. 7, 2003

(51) Int. Cl. C09D 11/00

(52) U.S. Cl. 106/31.13

(57) ABSTRACT

A photostorage and emission material with technology for altering color and methods of formulating luminescent inks for color separation of the artwork and printing full color pictorial images with realistic depth. The resulting full color pictorial images are visible in both conditions of reflected light in daylight as well as similar full color emission light in darkness. When the pictorial images are exposed to a bright light source to achieve complete excitation of the photostorage and emission material, the pictorial images exhibit high initial brightness and long glow duration time in darkness. The photostorage and emission inks are utilized in process color separations for printing pictorial images with standard equipment in the printing industry. The general methods utilized are: 1) mixtures of ink composed of photostorage and emission colorants, and 2) apply separate layers of ink, the first made with photostorage and emission colorants and the second made with emission colorants, and 3) apply a luminescent or photostorage and emission undercoating to the substrate, then transfer and bond a translucent pictorial image on top of the said undercoating to illuminate the printed image in darkness.

### BACKGROUND OF THE INVENTION

1. Field of Invention

This invention includes several methods of creating luminescent pictorial images with photostorage and emission colorants in inks utilizing process color separations for printing dot matrix format technology and/or luminescent undercoatings with standard equipment in printing methods such as screen printing, lithographic, flexographic, offset, graver, pad printing and image transfer printing.

2. Prior Art

Standard Process Color Technology is used commonly to print pictorial images for such items as books, magazines, and calendars. When the image is viewed under magnification, a matrix of round dots are revealed; some overlapping and some separate. The pictorial images are commonly separated into Standard Process Colors for printing, which typically include cyan blue, magenta, yellow and black.

The overlapping Process Colors result in creating many color combinations and shadows to create a pictorial image that reflects light into the observer's eye. The optic nerves of the eye send messages to the brain where a pictorial image is perceived. This technology utilizes reflected light to create a pictorial image. Therefore, when light is removed and the image is in dark, the observer may no longer see the pictorial image.

Similar technology is utilized to create pictorial images by emission light in such devices as televisions and computer monitors which also use a matrix of colors in a dot format, with some important exceptions. When the projected image is viewed under magnification, a matrix of round dots are revealed, some overlapping and some separate. However, the image is generally separated into different process colors than printing. The Standard Emission Process Colors are red, green, and blue.

Similarly, the overlapping Emission Process Colors in televisions and computer monitors result in creating many color combinations and shadows to create a pictorial image that emits light into the observer's eye. As in the previous example, the optic nerves of the eye send messages to the brain where a pictorial image is perceived. This technology utilizes emission light to create a pictorial image. However, when the electrical power is disconnected, the image is no longer visible.

Examples of the prior art are found in U.S. patent numbers as follows: U.S. Pat. Nos. 5,720,110; 5,599,048; 6,071,855; 5,997,992; and 5,695,809.

The methods for altering color in photostorage materials were developed earlier, and are described in the inventors' previous U.S. Pat. No. 6,177,029B1 titled A Photostorage and Emissive Material Which Provides Color Options dated Jan. 23, 2001, whose teachings and suggestions are incorporated by reference herein.

### SUMMARY OF THE INVENTION

It is a general object of the present invention to overcome the deficiencies and disadvantages of the prior art.

In particular, it is an object of the present invention to develop materials and techniques for creating full color pictorial images that may be perceived in both conditions of reflected light in daylight as well as similar full color emission light in darkness.

Another object of the present invention is to create luminescent pictorial images in darkness which feature high initial brightness and long glow duration time.

A third object of the present invention is to provide photostorage and emission materials (inks) to create full color pictorial images in both daylight and darkness that can be separated into Standard Process Color artwork for printing pictorial images utilizing standard equipment in the printing industry.

A forth object of the present invention is to create a realistic depth to pictorial artwork, with lighter colors appearing closer than darker shades in both conditions of reflected light in daylight and as well as similar realistic depth in darkness.

A fifth object of the present invention is to provide photostorage and emission materials (inks) to create full color pictorial images in both daylight and darkness that can be separated into Spot Color artwork for printing pictorial images utilizing standard equipment in the printing industry.

A sixth object of the present invention is to provide photostorage and emission materials (inks) to create full color pictorial images in both daylight and darkness that can be separated into Process Color artwork for printing pictorial images utilizing standard equipment in the printing industry.

A seventh object of the present invention is to provide photostorage and emission materials (inks) to create full color pictorial images in both daylight and darkness that can be separated into Index Color artwork for printing pictorial images utilizing standard equipment in the printing industry.

An eighth object of the present invention is to apply a luminescent or photostorage and emission undercoating to the substrate, then transfer and bond a translucent pictorial image to the said undercoating to illuminate the printed image in darkness.

A ninth object of the present invention is to accomplish all four aforementioned objects while printing the luminescent pictorial image with the least number of ink stations and the least number of ink applications for improved cost effectiveness.

It is a tenth object of the present invention to combine at least one and/or two or more different fluorescent colorant and/or optical brightener materials with one and/or two or more luminescent material in order to create a wide range of photostorage and emissive materials of different colors. This allows the creation of custom colors for manufacturers of products which provide a unique glow color appearance for improved product recognition and marketability. The new methodology of the present invention includes blending the photostorage and emission colorants into clear printing inks. These luminescent inks are utilized for printing of pictorial images. The luminescent inks are formulated to create full color pictorial images with realistic depth in both conditions of reflected light for daylight as well as similar full color glow emission light in darkness.

In keeping with the principles and objects of the present invention, the present invention is provided with four embodiments as is set forth in the paragraphs below.

In the first embodiment, luminescent colorants and fluorescent colorants are mixed together to create magenta, cyan blue and yellow emission process colors. The emission process colors are blended so that they match with and are compatible with magenta, cyan blue and yellow reflected process colors. These mixtures of reflected and emission process colors in magenta, cyan blue and yellow can be then utilized to print pictorial images in substrates such as T-shirts, pictures and posters.

In a second embodiment, natural luminescent colorants or a blend therof are each mixed separately with a fluorescent colorant(s) such as an optical brightener, with the option of translucent colorant(s) such as white. By way of example, photostorage and emission colorants are formulated to create White/Magenta, White/Cyan Blue, and White/Yellow. Each of these colorants, when blended with a clear printing ink, provide a white reflected color in daylight and have an emission color to essentially match Standard Process Colors. This printing process uses a dot process and is generally described as a dot matrix process. Specifically, if the dot is to be cyan blue, the mixture of natural blue luminescent colorant, optical brightener, and translucent white colorant in printing ink is fist printed on the substrate, such as a T-shirt. Then a dot of translucent cyan blue process color is printed on top of it. This same process would be utilized for a dot of magenta and yellow.

In a third embodiment, a luminescent or photostorage and emission undercoating is applied to the substrate, then a separate layer of translucent inks are printed on top to create a luminescent pictorial image. By way of example, a white glow undercoating is formulated with two or more of each material: luminescent colorants or a blend thereof, fluorescent colorant(s) such as an optical brightener, with the option of adding translucent colorant(s) such as white. These luminescent colorants or photostorage and emission materials are blended with clear ink and printed onto areas of artwork to be printed with a subsequent layer of translucent inks, particularly when the translucent inks are formulated with fluorescent colorants. The inventors discovered that transparent process color inks including magenta, cyan blue, and yellow work well for this subsequent layer.

In a forth embodiment, a luminescent or photostorage and emission undercoating is applied to the substrate. Then a translucent pictorial image is transferred and bonded to the said undercoating to illuminate the printed image in darkness. By way of example, a white glow emission undercoating is formulated with two or more of each material: luminescent colorants or a blend thereof, fluorescent colorant(s) such as an optical brightener, with the option of adding translucent colorant(s) such as white. These luminescent colorants photostorage and emission materials are blended with clear ink or transfer printing material then coated onto the substrate such as a T-shirt. Then a translucent printed image is transferred and bonded to the white glow undercoating to illuminate the printed image in darkness. This technique could be commercialized in the transfer T-shirt industry.

### DETAILED DESCRIPTION OF THE INVENTION

In practice, it is well recognized in industry that printing color inks on white stock or white undercoating will enhance the accuracy of the reflected color. Conversely, printing colors on a dark colored surface will shift or tint the reflected colors, which may render an inaccurate pictorial image.

Furthermore, it has been discovered by the inventors that a white stock material or undercoating containing an optical brightener (clear fluorescent) colorant additive will improve glow brightness and duration of the luminescent ink by as much as 40%, when compared to a dark surface.

In screen printing apparel, examples of white undercoating ink containing an optical brightener are Bright Tiger® manufactured by Wilflex and Phoenix® manufactured by Triangle Ink. However, a dark shirt could be flashed discharged (bleached) in the areas to be printed with similar results. An advantage of the flash discharge (bleach) method is a softer feel to the fabric achieved by eliminating one layer of ink, namely the white undercoating. In addition, if the color of the apparel is black, the area to be flashed discharged would be any artwork which is subsequently printed with luminescent inks.

The following section sets forth considerations when blending luminescent inks made with clear ink and photostorage and emission colorants for printing pictorial images and spot color areas.

1. In screen printing apparel the size of the colorant particles is important. By way of example, two size ranges of PERMAGLOW® colorants are available for formulation of photostorage and emission screen print inks. These size ranges are 200 mesh international (30-45 micron) and 500 mesh international (17-25 micron). The selection of the size range for PERMAGLOW® colorants is based upon the desired resolution, or detail in the artwork. The smaller size range of 500 mesh is utilized for fine artwork detail and luminescent process colors. The larger size range of 200 mesh is utilized for medium detail artwork that requires maximum glow brightness which is achieved with a larger luminescent crystal size range. The selection of size range of PERMAGLOW® colorants in ink formulation will also determine the screen size selection and ultimately, the resolution detail of the graphics.

2. A miniature colorant size is important in the printing processes of lithographic, flexographic, offset, graver, and pad printing. By way of example, many PERMAGLOW® colorants are available in a size range of 1-8 micron for formulation of photostorage and emission inks suitable for these printing processes.

3. Choose clear ink, which will effectively transfer light to the photostorage crystals that store energy. Ink clarity enhances both the glow brightness and duration of photostorage and emission materials. In screen printing apparel, an example of clear ink is Wilflex Finesse® ink.

4. Do not blend the photostorage and emission inks with opaque colorants or inks containing highly pigmented colors. The reason is the pigmented colorants shadow the photostorage and emission crystals from light, which reduces both the glow brightness and duration of glow.

5. Photostorage colorants are generally dense and heavy. For example, PERMAGLOW® crystals have a specific gravity of 3.7, which is almost four times the weight of water. Choose clear ink with a high viscosity, such as Wilflex Finesse® for screen printing graphics on apparel. If the chosen ink has a low viscosity, the dense PERMAGLOW® crystals will settle to the bottom of the ink formulation and will not print a clear image. To resolve this challenge, choose clear ink with a higher viscosity or blend an anti-settling agent which is matched to specific ink into the formulation. The optimum result is an even dispersion or distribution of PERMAGLOW® crystals which will enhance the luminescent image.

6. When blending the luminescent ink, the recommended loading ratio by weight for screen printing and most other printing methods is 1 part clear ink to 1 part photostorage and emission material (colorant), which is a 50% loading.

7. Blend the photostorage and emission colorants into the clear ink by gently stirring. Use of a low speed mixer equipped with a paddle type blade is preferred. Avoid high-speed mixers or placing the photostorage and emission colorants into roller mills, which will damage the luminescent crystals.

8. Since the photostorage and emission inks (colorants or materials) are translucent, it is necessary to apply them onto an opaque white surface containing an optical brightener additive. The benefits include 1) accurate reflected colors in daylight and 2) optimum emission colors in darkness. In screen printing apparel, effective white undercoating inks containing an optical brightener are, by way of example, Bright Tiger® by Wilflex and Phoenix® by Triangle Ink. Another method is to flash discharge (bleach) a dark color fabric bright white. Either way will improve glow brightness by as much as 40%.

9. Glow brightness and duration of photostorage and emission inks may be improved by increasing each of these factors: clarity of the ink prior to blending, loading of photostorage and emission colorants, and thickness of the luminescent ink layer on the apparel.

Photostorage and emissive colorants are blended with clear ink to create pictorial images in both daylight and darkness. The inventors discovered four (4) practical methods of achieving the objects of the present invention, which are described in the next three methods.

Method 1

The first method is to match the standard translucent process colors of Cyan Blue, Yellow, and Magenta to achieve both accurate reflected colors and accurate glow emission colors. This excludes Black, since the usage is to create shadows in the image.

The above method can be accomplished when the three process colors are formulated precisely to achieve two objectives. The important formulation goals to accomplish are to develop: 1) translucent process colors that blend to create accurate composite colors for a true pictorial image in daylight and 2) translucent luminescent process colors that blend to create accurate composite colors for a true pictorial image in darkness. The translucent process colors comprise a mixture of one or more of each of a photostorage material and a fluorescent material.

The inventors discovered that it is effective to highlight portions of the pictorial image in both daylight and darkness conditions. The idea is to create increased depth in the pictorial image with lighter colors appearing closer than darker areas. The objective of improved depth in the pictorial image was accomplished by formulating ink with a translucent white in daylight and a near white emission glow in darkness. By way of example, either an ink formulation for White/White or Highlight White (described later herein) may be utilized.

The inventors also experimented with three methods to print shadows and create realistic depth in the luminescent pictorial image. For the purpose of discussion herein, reference is provided to the Process Color technique of color separation utilizing a dot matrix format. However, other techniques of color separation could be utilized to apply the following methods of printing shadows, without departing from the spirit of the invention.

The first method is to separate and print black ink in the areas containing shadows, which is a common practice in printing. The second method is used with black apparel or substrates in which the areas containing shadows are not printed with ink, and thus the dark areas provide a perceived depth in the image. This method is often utilized in the screen printing of pictorial images on apparel, for example black T-shirts.

A third and totally new method the inventors discovered is to separate and print a photostorage and emission ink that is a dark color, by way of example royal blue or dark blue glow. Then a subsequent layer of translucent black ink, such as process black is printed on top of the photostorage and emission ink to tint the shadow area a darker shade. By balancing the appropriate glow brightness and color tone with the remaining portion of the image, those skilled in the art of separation and printing are able to achieve impressive results. The shadow areas actually glow with the rest the pictorial image and provide realistic depth.

In practice, the inventors found that effective ink formulations for Emission Process Colors, by way of example, in screen printing pictorial images on apparel are composed of 40-70% by weight clear ink and 30-60% photostorage and emissive material by weight. Suitable photostorage and fluorescent materials and combinations thereof are shown in U.S. Pat. No. 6,177,029 B1. Effective ink formulations the inventors have utilized are summarized below. However, other constituents and/or ink formulations that provide practicality to printing luminescent pictorial images could be utilized, without departing from the spirit of the invention.

Process Cyan Blue Ink Formulation by Weight

30-50% Natural Blue PERMAGLOW® (photostorage material)

0.5-10% Fluorescent Blue colorant

40-70% Clear Ink

Process Yellow Ink Formulation by Weight

30-50% Natural Yellow PERMAGLOW® (photostorage material)

0.5-7.0% Fluorescent colorant

0.01-1.0% Fluorescent Red RD colorant

40-70% Clear Screen Print Ink

Process Magenta Ink Formulation by Weight

30-50% Natural Green PERMAGLOW® (photostorage material)

1-20% Natural Blue PERMAGLOW® (photostorage material)

0.5-10% Fluorescent Magenta colorant

40-70% Clear Ink

White/White Ink Formulation by Weight

30-50% Natural White PERMAGLOW® (photostorage material)

0.1-10% White Optical Brightener (clear fluorescent with translucent white colorant)

40-70% Clear Ink

Highlight White Ink Formulation by Weight

5-30% Natural Red PERMAGLOW® (photostorage material)

5-30% Natural Yellow PERMAGLOW® (photostorage material)

5-30% Natural Green PERMAGLOW® (photostorage material)

5-30% Natural Blue PERMAGLOW® (photostorage material)

1-20% White Optical Brightener (clear fluorescent with translucent white colorant)

40-70% Clear Ink

Method 2

Another method to achieve the stated objectives is by printing luminescent ink layers followed by translucent inks, particularly when the translucent inks are formulated with fluorescent colorants. It was discovered that the ideal reflected color in daylight for the luminescent ink layers would be translucent white for optimum reflectance of the translucent colors in daylight and accurate transmission of emission colors in darkness.

It was also discovered that in practice, matching the glow emission color of the luminescent ink with the reflected color of each subsequent layer of translucent ink has some important advantages. Specifically, this technique provides an accurate rendering of the pictorial image in both daylight and darkness.

In this method, formulation can be accomplished by blending clear printing ink with natural luminescent colorant(s) or blends thereof, and fluorescent colorant(s) such as an optical brightener, with the option of adding translucent colorants such as white. The goals are to provide a balance of white reflected color in daylight, maximum glow brightness, and an accurate color emission to the match subsequent translucent ink layer.

By way of example, clear printing ink is formulated with natural luminescent colorant or blends thereof that are selected to provide a glow emission to match the process colors of magenta, cyan blue, and yellow. Each are formulated separately with an optical brightener, with the option of adding a translucent white colorant to create a white/magenta, white/cyan blue, and white yellow. These new printing inks provide a white reflected color in daylight and have an emission color to essentially match translucent process color inks that are applied on top of them.

The process color technology of separation and printing uses a dot matrix format. Specifically, if the dot is to be cyan blue, the mixture of White/Cyan Blue photostorage and emission ink is printed on the substrate, such as a t-shirt. Then a dot of translucent cyan blue process color is printed on top of it. This same process would be utilized for a dot of magenta and yellow. While the above example utilizes the process color technique of color separation and printing, those skilled in printing could utilize other techniques of separation and printing without departing from the spirit of the invention.

As previously explained in the section titled Method 1, the inventors discovered that it is effective to highlight portions of the pictorial image in both daylight and darkness conditions. The idea is to create increased depth in the pictorial image with lighter colors appearing closer than darker areas. As explained before, the objective of improved depth in the pictorial image was accomplished by formulating ink with a translucent white in daylight and a near white emission glow in darkness. Either of the ink formulation for White/White or Highlight White may be utilized.

As previously explained in the Method 1 section, the inventors experimented with three methods to print shadows and create realistic depth in the luminescent pictorial image. For the purpose of discussion herein, reference is provided to the Process Color technique of color separation utilizing a dot matrix format. However, other techniques of color separation could be utilized to apply the following methods without departing from the spirit of the invention.

The first method is to separate and print black ink in the areas containing shadows, which is a common practice in printing. The second method is used with black apparel or substrates in which the areas containing shadows are not printed with ink, and thus the dark areas provide a perceived depth in the image. This method is often utilized in the screen printing of pictorial images on apparel, for example black T-shirts.

A third and totally new method the inventors discovered is to separate and print a photostorage and emission ink that is a dark color, by way of example royal blue or dark blue. Then a subsequent layer of translucent black ink, such as process black is printed on top of the photostorage and emission ink to tint the shadow area a darker shade. By balancing the appropriate glow brightness and color tone with the remaining portion of the image, those skilled in the art of separation and printing are able to achieve impressive results. The shadow areas actually glow with the rest of the pictorial image and provide realistic depth.

In practice, the inventors found that effective ink formulations for Emission Process Colors which reflect white in daylight for use, by way of example, in screen printing pictorial images on apparel are composed of 40-70% by weight clear ink and 30-60% by weight photostorage and emissive material. Effective ink formulations the inventors have utilized are summarized below. However, other constituents and/or ink formulations that provide practicality to printing luminescent pictorial images could be utilized, without departing from the spirit of the invention.

White/Cyan Blue Ink Formulation by Weight

30-50% Natural Blue PERMAGLOW (photostorage material)

0.5-10% White Optical Brightener (clear fluorescent with translucent white colorant)

40-70% Clear Ink

White/Yellow Ink Formulation by Weight

30-50% Natural Yellow PERMAGLOW® (photostorage material)

0.5-10% White Optical Brightener (clear fluorescent with translucent white colorant)

40-70% Clear Screen Print

White/Magenta Ink Formulated by Weight

30-50% Natural Blue PERMAGLOW® (photostorage material)

0.5-10% Natural Red PERMAGLOW® (photostorage material)

0.5-10% White Optical Brightener (clear fluorescent with translucent white colorant)

40-70% Clear Ink

White/White Ink Formulation by Weight

30-50% Natural White PERMAGLOW® (photostorage material)

0.5-10% White Optical Brightener (clear fluorescent with translucent white colorant)

40-70% Clear Ink

Highlight White Ink Formulation by Weight

5-30% Natural Red PERMAGLOW® (photostorage material)

5-30% Natural Yellow PERMAGLOW® (photostorage material)

5-30% Natural Green PERMAGLOW® (photostorage material)

5-30% Natural Blue PERMAGLOW® (photostorage material)

0.5-10% White Optical Brightener (clear fluorescent with translucent white colorant)

40-70% Clear Ink

Method 3

A third method is to choose luminescent colorant(s) or blends thereof; or create a photostorage and emissive material that appears white in daylight and has a white emission glow. These said colorants are blended with clear ink and printed onto areas of artwork to be printed with a subsequent layer of translucent inks, particularly when the translucent inks are formulated with fluorescent colorants.

In this method, formulation can be accomplished by blending clear printing ink with natural luminescent colorant(s) or blends thereof, and fluorescent colorant(s) such as an optical brightener, with the option of adding translucent colorants such as white. The goals are to provide a balance of white reflected color in daylight, maximum glow brightness, and a white emission color.

Subsequently, the next layers of translucent color inks are printed to achieve two results: 1) reflected colors in daylight, and 2) emission colors in darkness. By way of example, the inventors discovered that transparent process color inks including magenta, cyan blue, and yellow work well for this subsequent layer, excluding black to create shadows. Those that are skilled in the art of process color separation and printing are able to create accurate pictorial images in both daylight and darkness conditions.

As explained in the previous two methods, the inventors discovered that it is effective to highlight portions of the pictorial image in both daylight and darkness conditions. The idea is to create increased depth in the pictorial image with lighter colors appearing closer than darker areas. As explained before in the previous methods, the objective of improved depth in the pictorial image was accomplished by formulating ink with a translucent white in daylight and a near white emission in darkness. Either the ink formulation for White/White or Highlight White (described herein in the following) may be utilized.

As explained in the previous two sections, the inventors experimented with three methods to print shadows in the pictorial image to create realistic depth in the luminescent pictorial image. The techniques are the same for this method and may be reviewed by referring to the appropriate text in the sections titled Method 1 and Method 2.

In practice, the inventors found that effective ink formulations for Emission Process Colors which reflect white light in daylight and emit white light for use, by way of example, in screen printing pictorial images on apparel are composed of 40-70% by weight clear ink and 30-60% by weight photostorage and emissive material. Effective ink formulations the inventors have utilized are summarized below. However, other constituents and/or ink formulations that provide practicality to printing luminescent pictorial images could be utilized, without department from the spirit of the invention.

White/White Ink Formulation by Weight

30-50% Natural White PERMAGLOW® (photostorage material)

0.1-10% White Optical Brightener (clear fluorescent with translucent white colorant)

40-70% Clear Screen Print Ink

Highlight White Ink Formulation by Weight

5-30% Natural Red PERMAGLOW® (photostorage material)

5-30% Natural Yellow PERMAGLOW® (photostorage material)

5-30% Natural Green PERMAGLOW® (photostorage material)

5-30% Natural Blue PERMAGLOW® (photostorage material)

1-20% White Optical Brightener (clear fluorescent with translucent white colorant)

40-70% Clear Ink

Method 4

Another method to achieve the stated objectives is to create a luminescent undercoating on the substrate and laminate a translucent pictorial image to the undercoating. It was discovered that the ideal reflected color in daylight for the luminescent undercoating would be translucent white for optimum transmission of the translucent pictorial image in darkness. In addition, it was discovered that the ideal pictorial image would be printed with translucent inks, preferably those containing fluorescent colorants. By way of example, those that were found to be effective include the standard translucent process colors of magenta, cyan blue, yellow and black.

In this method, the goals for selection of luminescent undercoating are: accurate reflection of the translucent pictorial image in daylight, maximum glow brightness, and an accurate color emission of the translucent pictorial image in darkness. The inventors discovered an effective formulation could be accomplished by blending natural luminescent colorant(s) or blends thereof, and fluorescent colorants(s) such as an optical brightener, with the option of adding a translucent colorant(s) such as white.

This white glow emission colorant is blended with printing ink or transfer-printing material then coated on the substrate such as a T-shirt. Then a translucent printed image is transferred and bonded to the white glow undercoating to illuminate the printed image in darkness. Those that are skilled in the art of transfer printing are able to achieve outstanding results of accurate pictorial images in both daylight and darkness conditions. This technique could be commercialized in the transfer T-shirt industry.

In practice, the inventors found that effective ink formulations for white emission glow undercoatings for use, by way of example, in transfer printing pictorial images on apparel are composed of 40%-70% by weight clear ink or transfer printing material and 30%-60% by weight photostorage and emissive material. Specific ink formulations the inventors have utilized are summarized below:

White/White Ink Formulation by Weight

30-50% Natural White PERMAGLOW® (photostorage material)

1-20% White Optical Brightener (clear fluorescent with translucent white colorant)

40-70% Clear Printing Ink

Highlight White Ink Formulation by Weight

5-30% Natural Red PERMAGLOW® (photostorage material)

5-30% Natural Yellow PERMAGLOW® (photostorage material)

5-30% Natural Green PERMAGLOW® (photostorage material)

5-30% Natural Blue PERMAGLOW® (photostorage material)

1-20% White Optical Brightener (clear fluorescent with translucent white colorant)

40-70% Clear Printing Ink or Clear Transfer Print Material

An advantage to Method 4 is that the forth object of the present invention is accomplished. Specifically, this printing method of the luminescent pictorial image is achieved with the least number of ink stations and the least number of ink applications for improved cost effectiveness.

Effective Techniques for Color Separation and Printing for the Invention

A key factor in printing luminescent pictorial images is to select the best color separation method(s) for the artwork provided. It is sometimes necessary to combine separation techniques to achieve the desired results. These section outlines methods for color separation and by way of example, screen printing garments. However, the techniques presented may be utilized in several printing methods such as: lithographic, flexographic, offset, graver, pad printing, and transfer printing without departing from the spirit of the invention.

Separating artwork for garment printing can be a difficult puzzle to solve, even when the printer is utilizing a powerful and capable program like Adobe Photoshop®. The key to this challenge is to understand the separation methods available and the types of images for which each method is most appropriate. The separation methods for creation of luminescent pictorial images that are discussed in this section include: Spot Color, Process Color, Simulated Process Color, and Index Color.

The content of the image will sometimes suggest the separation method to use, however, the printing professional must keep in mind the production variables that are necessary to control for each method to deliver the desired results. It becomes much easier for the printer to choose the right method if the printer has a realistic view of the production capabilities and the degree to which key variables can be controlled by screen makers, ink technicians, and press operators.

In general, the most appropriate method of separation is always the one that works best with the image composition and will accurately reproduce the visual impact of the original. Four primary separation methods are useful to garment printers: spot color, process color, simulated process color, and index color. The following sections explain which design types are best supported by these separation methods.

Spot Color

Spot color graphics are still the most common in the screen printed garment industry since they are easy to design, separate and print. Designs that need spot color separations are generally composed of solid, flat colors that are printed next to each other, occasionally with black outlines to assist in trapping. Spot color prints generally look more like clip art or other vector-based computer graphics rather than photographs.

If the job requires portion of the image to have high color accuracy, it is best to match the colors to Pantone® spot colors and print them as separate standalone colors. The inventors discovered a majority of the colors in the Pantone® book of standard colors, in particular those that are light to medium tone,are practical for formulation of photostorage and emission inks with excellent accuracy and repeatability.

The photostorage and emission inks blended to match the spot colors are transparent, and therefore work best when applied to white substrates. This will improve glow brightness by as much as 40%, while providing color accuracy in both daylight and darkness. By way of example in screen printing garments, three techniques of color separation are practical. These include: select white garments (no separation), color garments with an application of a white undercoating containing an optical brightener (one separation), and colored garments that are flash discharged (bleached) in the area to be printed with photostorage an emission inks (one separation).

Most spot color graphics are separated using the vector graphics program in which they were created, such as CoreDRAW!® or Illustrator®. These programs can better retain the image clarity of a vector file than Photshop®, which works with bitmap images.

Process Color

Process color printing involves precisely placing dots of four different colors, (cyan, magenta, yellow, and black) in combinations to appear as a broad spectrum of color. In general, achieving precise dot control is a skill that experienced printers in the art achieve by successfully mastering the variables that affect process color reproduction. In particular, those that influence dot gain, hue error, gray balance and color over-saturation.

Images that make good color process prints generally begin as full color photographs or generated artwork with colors that blend together smoothly. The most difficult process color applications are those that have colors that the viewer remembers if they are slightly out of hue, such as skin tones, wood, and chrome.

If the job requires portions of the image to have high color accuracy, it is best to match the colors to Pantone® spot colors and print them as separate, standalone colors rather than trying to emulate them with process color inks. As previously stated, the inventors discovered a majority of the colors in the Pantone® book of standard colors, in particular those that are light to medium tone, are practical for formulation of photostorage and emission inks with excellent accuracy and repeatability.

As explained previously, the photostorage and emission inks blended to match Pantone® colors and the standard process colors are transparent, and therefore work best when applied on white substrates. This will improve glow brightness and duration by as much as 40%, while providing color accuracy in both daylight and darkness conditions. By way of example, in screen printing garments three techniques of creating a white under base are practical. These include: select white garments (no separation required), colored garments with an application of a white undercoating containing an optical brightener (one separation), and colored garments that are flash discharged (bleached) in the area to be printed with photostorage and emission inks (one separation).

As previously revealed, the inventors discovered three methods that are practical for application of the invention utilizing the process color separation technique. To review Method 1, photostorage and emission inks are blended so they match with and are compatible with magenta, cyan blue, and yellow process colors for separating and printing a luminescent pictorial image. In Method 2, photostorage and emision inks are blended to create White/Magenta, White/Yellow, and White/Cyan Blue and the corresponding translucent process color inks are printed over them to develop a luminescent pictorial image. In method 3, a translucent white photostorage and emission ink is printed in the area to be followed by standard process color inks to develop a luminescent pictorial image.

The color separation(s) for black would be dependent upon which one of the techniques was selected for creating shadow depth in the image. The first technique of printing standard black ink on the substrate that is not luminescent would utilize one separation. The second technique of printing on a black substrate would not require any separations, since black is already present on the substrate. The third and new technique of printing a medium to dark blue photostorage and emission ink followed by a translucent black ink to tint the shadows dark and emit a faint luminescent color would require at least two separations.

The white and highlighted portions of the image can be separated and printed to appear closer, adding realistic depth to the image. Examples of areas to highlight include: reflections on water or smooth surfaces, sunlit areas, and surfaces in the image that are closest to the viewer. Computer software programs such as Photoshop® assist the printer in creating separations for highlighted areas.

In order to have the highlighted portions of the image to appear closer, choose a near white photostorage and emission ink, by way of example, Highlight White or White/White. To achieve bright white highlights in the image, utilize an opaque white undercoating containing an optical brightener, since the photostorage and emission colorants are translucent. The number of separations required for highlighting will in all probability between one and no more than three.

It is highly recommended that all the equipment utilized in the process color separations be carefully calibrated to ensure accuracy. This includes scanner, computer monitor, design software, screens, presses, and inks.

An accepted design software package for process color separation of artwork for screen printing garments is Photoshop®. This software allows the printing professional to accurately complete the following tasks:

1. Adjust color settings of the image.

2. Convert the file to process colors of cyan, magenta, yellow, and black.

3. Edit the individual color channels for improved accuracy.

4. Create separations for printing.

Simulated Process Color

Simulated process color separations are used to create the illusion of four color process by using many colors that overlap and blend together in the final print. This method is most useful when it is desired to produce a wider spectrum of color than could with conventional process color or when the image is printed on a darker substrate, for example a dark garment.

Similar to four color process images, designs that can be separated with simulated process colors are often more realistic or complex. However, a drawback to the simulated process color method is that in order to deliver a broader color spectrum, it is often necessary to utilize twice as many color separations as in a four-color process print.

For best results, the printer should select photostorage and emission inks that are as close as possible to the colors that were selected when creating the separations. To ensure high color accuracy, it is best to match the colors to Pantone® spot colors and print them as separate, standalone color inks. As revealed previously, the inventors discovered a majority of the colors in the Pantone® book of standard colors, in particular, those that light to medium tone, are practical for formulation of photostorage an emission inks with excellent accuracy and repeatability.

As explained previously, the photostorage and emission inks blended to match Pantone® colors are transparent, and therefore work best when applied on white substrates. This will improve glow brightness by as much as 40%, while providing color accuracy in both daylight and darkness conditions. By way of example, in screen printing garments three techniques of creating a white under base are practical. These include: select white garments (no separation required), colored garments with an application of a white undercoating containing an optical brightener (one separation), and colored garments that are flash discharged (bleached) in the area to be printed with photostorage an emission inks (one separation).

As previously revealed, the inventors discovered three methods that are practical for the application of the invention utilizing the simulated process color technique. To review Method 1, photostorage and emission inks are blended so they match with and are compatible with the selected simulated process colors for separating and printing a luminescent pictorial image. In method 2, photostorage and emission inks are blended to create a translucent white reflected color with an emission color to match the corresponding translucent simulated process color inks that are printed over them to develop a luminescent pictorial image. In Method 3, a translucent white photostorage and emission ink is printed in the area to be followed by standard process color inks to create a luminescent pictorial image.

As previously described, the color separation(s) for black would be dependent upon which one of the techniques was selected for creating shadow depth in the image. The first technique of printing standard black ink on the substrate that is not luminescent would utilize one separation. The second technique of printing on a black substrate would not require any separations. The third and new technique of printing a medium to dark blue photostaorage and emission ink followed by a translucent black ink to tint the shadows dark and emit a faint luminescent color would require at least two separations.

As previously explained, the white and highlighted areas of the image can be separated and printed to appear closer, adding realistic depth to the image. Examples of areas to highlight include: reflections on water or smooth surfaces, sunlit areas, and surfaces in the image that are closest to the viewer. Computer software programs such as Photoshop® assist the printer in creating separations in highlighted areas.

In order to have the highlighted portions of the image appear closer, choose a near white photostorage and emission ink, by way of example, Highlight White or White/White. To achieve bright white highlights in the image, utilize an opaque white undercoating containing an optical brightener, since the photostorage and emission inks are translucent. The number of separations required for highlighting will in all probability be between one and no more than three.

It is highly recommended that all the equipment utilized in the simulated process color separations be carefully calibrated to ensure accuracy. This includes scanner, computer monitor, design software, screens, presses, and inks.

An accepted design software package for simulated process color separation of artwork for screen printing garments is a Photoshop® plug in program such as Fast Films®, Color Crunch®, or QuikSeps®. These software packages allow the printing professional to accurately complete the following tasks:

1. Prepare the image.

2. Create the under base.

3. Select the separation colors.

4. Edit and preview the channels.

5. Import under base and create highlight white separation.

6. Edit channels that don't blend.

7. Create separations for printing.

Index Color

Index color separations use the power of Photoshop® software to force an image to be reproduced with a limited palette of colors that are blended or “dithered” together using a random dot pattern. An example of artwork that would utilize this method is an artist portrait of a wolf or dog, wherein the color palette is limited and repeated. The advantages to using this method is that registration of the image is less critical than some of the separation styles, since all the dots in the image are the same size and their placement is random.

The nature of the index color separation method requires high color accuracy, an therefore it is best to match the photostorage and emission inks to Pantone® colors and print them dithered together using a random dot pattern. As previously stated, the inventors discovered majority of the colors in the Pantone® book of standard colors, in particular, those that are light to medium tone, are practical for formulation of photostorage and emission inks with excellent accuracy and repeatability.

As explained previously, the photostorage and emission inks blended to match the Pantone® colors are transparent, and therefore work best when applied on white substrates. This will improve glow brightness by as much as 40%, while providing color accuracy in both daylight and darkness conditions. By way of example, in screen printing garments three techniques of creating a white under base are practical. These include: select white garments (no separation required), colored garments with a white undercoating containing an optical brightener (one separation), and colored garments that are flash discharged (bleached) in the area to be printed with photostorage and emission inks (one separation).

As previously revealed, the color separation(s) for black would be dependent upon which one of the techniques was selected for creating shadow depth in the image. The first technique of printing standard black ink on the substrate that is not luminescent would utilize one separation. The second technique of printing on a black substrate would not require any separations, since black is already present on the substrate. The third and new technique of printing a medium to dark blue photostorage and emission ink followed by a translucent black ink to tint the shadows dark and emit a faint color would require at least two separations.

As previously explained, the white and highlighted areas of the image can be separated and printed to appear closer, adding realistic depth to the image. Examples of areas to highlight include: reflections on water or smooth surfaces, sunlit areas, and surfaces in the image that are closest to the viewer, and sunlight areas. Computer software programs such as Photoshop® assist the printer in creating separations for highlighted areas.

In order to have the highlighted portion of the images to appear closer, choose a near white photostorage and emission ink, by way of example, Highlight White or White/White. To achieve bright white highlights in the image, utilize an opaque white undercoating containing an optical brightener, since the photostorage and emission inks are translucent. The number of separations required for highlighting will in all probability be between one and no more than three.

It is highly recommended that all the equipment utilized in the index color separations be carefully calibrated to ensure accuracy. This includes scanner, computer monitor, design software, screens, presses, and inks.

Making quality index separations requires many of the same skills that are used for simulated process color. Photoshop® software allows the printing professional to accurately complete the following tasks:

1. Prepare the image.

2. Create the under base and highlight channels.

3. Convert the original file to index color and select colors.

4. Create colors from the selected custom colors.

5. Create the separations for printing.

Summary

This overview of the four main color separation methods for creation of luminescent pictorial images, helps to reveal how a printer decides what types of images are best suited for each method. The techniques can be combined to solve difficult separation challenges. While the examples utilized herein are for screen printing garments, the techniques are applicable to other printing methods without departing from the spirit of the invention.

In addition, while the previous descriptions of the present invention were explained utilizing four print methods and four color separation methods, one or more of the printing methods and one or more of the color separation methods can be combined to print any given image. It should be apparent to one of ordinary skill in the art, that the above description is not meant to limit the invention. Numerous and varied embodiments of the present invention can be created without departing from the spirit and scope of the invention.

1. A process for printing a multi-color image with reflected colors in the light and emission colors in the dark which are perceived by a viewer substantially the same, said process comprising the steps of:
creating at least three printing inks capable of printing said multi-color image, each of said three printing inks being made by the process of:
mixing together two or more materials selected from the group consisting of a photostorage material, a fluorescent colorant and mixtures thereof to form a composite color which appears as the same reflected color in light as emission color in the dark; and
mixing said composite color with a printing ink which is at least translucent; and
printing said multi-color image on said substrate using said two or more printing inks.

2. The process according to claim 1, wherein said printing is performed by a screen print process.

3. The process according to claim 2, wherein said clear printing ink comprises 40-70% by weight of each of the two or more printing inks.

4. The process according to claim 3, further comprising the step of bleaching said substrate white before printing said multi-color image.

5. The process according to claim 1, further comprising the steps of highlighting a portion of the said multi-colored image to create increased depth.

6. The process according to claim 1, further comprising the steps of shadowing a portion of the said multi-colored image to create increased depth.

7. The process according to claim 6, wherein said print is performed by a dot-matrix format.

8. The process for printing a multi-color image with reflected colors in the light and emission colors in the dark which are perceived by a viewer substantially the same, said process comprising the steps of:
creating at least two or more printing inks capable of printing said multi-color image, each of said two or more printing inks being made by the process of:
mixing together one or more selected from the group consisting of a photostorage material, a fluorescent colorant and mixtures thereof to form a composite color which appears as the same reflected color in light as emission color in the dark; and
mixing said composite color with a screen print ink which is at least translucent; and
printing said multi-color image on said substrate using said two or more printing inks; and
printing translucent process color inks to create said multi-color image.

9. The process according to claim 8 wherein said printing is performed by screen print process.

10. The process according to claim 9, wherein said clear printing ink comprises 30-70% by weight of each of the two or more printing inks.

11. The process according to claim 10, further comprising the step of bleaching said substrate white before printing said multi-color image.

12. The process according to claim 8, wherein said printing is performed by a dot-matrix format.

13. The process according to claim 8, further comprising the steps of highlighting a portion of the said multi-colored image to create increased depth.

14. The process according to claim 8, further comprising the steps of shadowing a portion of the said multi-colored image to create increased depth.

15. A process for printing a multi-color image with reflected colors in the light and emission colors in the dark which are perceived by a viewer as substantially the same, said process comprising the steps of:
creating at least two or more printing inks capable of printing said multi-color image, that appear white in daylight and glow different emission colors, each of said two or more printing inks being made by the process of:
mixing together two or more materials selected from the group consisting of: a photostorage material, a fluorescent colorant and mixtures thereof, an optical brightener, and translucent colorant(s) such as white; and
mixing said composite white colorants with a printing ink which is clear or at least translucent; and
printing said composite white printing inks on said substrate; and
printing translucent process colors on said image to form said multi-color image.

16. The process according to claim 15, wherein said white fluorescent colorant is an optical brightener that may be blended with a translucent colorants to achieve a white reflected color.

17. The process according to claim 15, wherein said printing is performed by a screen print process.

18. The process according to claim 17, wherein said clear printing ink comprises 40%-70% by weight of each of the two or more printing inks.

19. The process according to claim 18, further comprising the step of bleaching said substrate white before printing said multi-colored image.

20. The process according to claim 15, wherein said printing is performed by a dot matrix format.

21. The process according to claim 15, further comprising the steps of highlighting a portion of the said multi-colored image to create increased depth.

22. The process according to claim 15, further comprising the steps of shadowing a portion of the said multi-colored image to create increased depth.

23. A process for printing a multi-color image with reflected colors in the light and emission colors in the dark which are perceived by a viewer substantially the same, said process comprising the steps of:
creating a composite white colorant, said composite white colorant comprising a mixture of at least two ore more materials selected from the group consisting of a photostorage material, a fluorescent colorant and mixtures thereof, an optical brightener, and a translucent white colorant; and
mixing said composite white colorant with a printing ink which is at least translucent; and
printing a white glow undercoating on the area of said substrate using said composite white printing inks; and
printing translucent process ink colors on said image to form said multi-color image.

24. The process according to claim 18, wherein printing is performed by a screen print process.

25. The process according to claim 24, wherein said printing ink comprises 40-70% by weight of the composite white printing ink.

26. The process according to claim 24, further comprising the step of bleaching said substrate white before printing said multi-color image.

27. The process according to claim 23, wherein said printing is performed by a dot-matrix format.

28. The process according to claim 23, further comprising the steps of highlighting a portion of the said multi-colored image to create increased depth.

29. The process according to claim 23, further comprising the steps of shadowing a portion of the said multi-colored image to create increased depth.

30. A process for printing a multi-color image with reflected colors in the light and emission colors in the dark which are perceived by a viewer substantially the same, said process the steps of:
creating a composite white colorant; said composite white colorant comprising a mixture of at least two or more materials consisting of: a photostorage material, a fluorescent colorant and mixtures thereof, an optical brightener, and translucent colorants such as white; and
mixing said composite white emission colorant with a printing ink or transfer printing material which is clear or at least translucent; and
printing said composite white emission printing inks or transfer printing material on said substrate; and
transferring or laminating a translucent pictorial image onto said white emission printing inks or transfer printing material.

31. The process according to claim 30, wherein said white fluorescent is an optical brightener that may be blended with a translucent white colorant.

32. The process according to claim 30, wherein said printing is performed by a screen print process.

33. The process according to claim 32, wherein said clear printing ink or transfer material comprises 40%-70% by weight of the white glow emission composite.

34. The process according to claim 30, wherein said translucent pictorial image is developed and laminated to said white glow emission undercoating utilizing transfer print technology for decorating apparel and goods.

35. The process according to claim 1, 8, 15, 23 and 30, further comprising the Spot Color separation method for printing luminescent pictorial images.

36. The process according to claim 1, 8, 15, 23 and 30, further comprising the Process Color separation method for printing luminescent pictorial images.

37. The process according to claim 1, 8, 15, 23 and 30, further comprising the Simulated Process Color separation method for printing luminescent pictorial images.

38. The process according to claim 1, 8, 15, 23 and 30, further comprising the Index Color separation method for printing luminescent pictorial images.
